(19) United States
(12) Patent Application Publication
(10) Pub. No.: US 2025/0280944 A1
(43) Pub. Date: Sep. 11, 2025

(54) CAULKING GUN HOLSTER

(71) Applicant: Diarmuid Griffin, Woodland Hills, CA (US)

(72) Inventor: Diarmuid Griffin, Woodland Hills, CA (US)

(21) Appl. No.: 18/601,873

(22) Filed: Mar. 11, 2024

(51) Int. Cl. A45F 5/02; B05C 17/005

(52) U.S. Cl. CPC A45F 5/021; B05C 17/0052; A45F 5/1575

(57) ABSTRACT

An apparatus for retaining a caulking gun to more readily store and use the caulking gun as needed. The apparatus further providing a stable location attached to a user's belt for the caulking gun to be retained during non-use. The apparatus further providing a rigid platform that includes a cup for the nozzle of the caulking gun, a retaining ring to retain the nozzle portion of the caulking gun, a loop member for retaining the entire platform to a belt, and a ratchet retaining assembly to retain the ratchet portion of the caulking gun to the platform.

### CROSS REFERENCE TO RELATED APPLICATIONS

This application claims priority from provisional patent application 62/711,579, filed on July 29, 201, which is incorporated by reference herein.

### BACKGROUND

The present invention relates generally to the field of construction tool holders, and more particularly to a caulking gun holder or holster.

The present invention is an apparatus for retaining a caulking gun to more readily use the caulking gun when needed. During a construction project, construction workers consistently have the need to use a caulking gun to create a water tight seal or to fill a gap. Often, immediately after use of a caulking gun, both hands of the construction worker are needed to perform a secondary task. Under this circumstance, the construction worker is forced to make a decision to either set the caulking gun down where the caulking gun may leak silicone or latex or hold the caulking gun with one hand and perform the secondary task with only one free hand.

Placing the caulking gun down can lead to leaks from the gun requiring frequent cleanups. The caulking gun can also be misplaced, causing lost time as a worker looks for the gun, or even removed from the work area by a co-worker and perhaps discarded in the trash.

There is a need for a retention caulk gun holster that can easily retain a caulking gun to a worker for easy access.

### SUMMARY

The present application discloses a caulking gun holder or holster that can retain a caulking gun on a tool belt and free a workers hands for other tasks.

In some embodiments, the inventions include a caulking gun holster, also called a caulking gun holder, described herein can securely retain the caulking gun on a construction worker's tool belt making with a portion of the caulking gun holster including a nozzle cup to cover the caulking gun applicator (i.e., the nozzle) and capture any leaking material from the caulking tube retained in the caulking gun. The disclosed caulking gun holster can be retained by one belt loop so that the caulking gun rests against a person's leg, between the person's waist and the person's knee.

In some embodiments, the inventions include a slender rigid platform containing a cup for the nozzle of the caulking tube, a ring having an opening perpendicular to the platform to retain the nozzle portion of the caulking tube, a loop member for retaining the entire platform to a belt, and a ratchet retaining member to retain the ratchet portion of the caulking gun to the platform. A retaining assembly press fit retains the ratchet portion of the caulking gun. The cup can retain the excess flow from the caulking tube and can be unscrewed to be emptied.

The present invention is an apparatus for retaining a caulking gun, the apparatus comprising:
a. a rigid platform having a length and a platform top surface having a retention cap and a ratchet retaining assembly affixed to said platform top surface;
b. at least one loop member adjacent to a top of said rigid platform of a caulking gun holster body, with said at least one loop member affixed to said platform;
c. the ratchet retaining assembly comprising two oppositely oriented spring-loaded roller clamps and configured so as to expand apart when a ratchet of a caulking gun is inserted therein;
d. a nozzle of a caulking tube in the caulking gun inserted into the retention cap to retain the nozzle therein, with said nozzle at a front end of the caulking gun and having a rear end of the caulking gun comprising a caulking gun ratchet, the caulking gun ratchet placed into the spring-loaded roller clamps, and the caulking gun ratchet pressed downwards into the spring-loaded roller clamps, so the spring-loaded roller clamps close on the caulking gun ratchet to retain the caulking gun ratchet.

Further novel features and other objects of the present invention will become apparent from the following detailed description and discussion.

The disclosed innovations, in various embodiments, provide one or more of at least the following advantages. However, not all of these advantages result from every one of the innovations disclosed, and this list of advantages does not limit the various claimed inventions.
Increased productivity.
Ease of carrying a caulking gun on a tool belt.
Improved cleanliness.
Decreased incidents of waste from losing caulking guns and leaking caulk.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 is a top perspective view of the present invention caulking gun holster and a detached caulking gun;

FIG. 2 is a bottom perspective view of the present invention caulking gun holster;

FIG. 3 is a side perspective view of a portion of the present invention caulking gun holster;

FIG. 4 is a close up view of the nozzle retention cap of the present invention caulking gun holster;

FIG. 5 is a close up view of the retention ring and nozzle cup of the present invention caulking gun holster;

FIG. 6 is an end view of the ratchet retention assembly of the present invention caulking gun holster;

FIG. 7 is a side perspective view of the ratchet retention assembly of the present invention caulking gun holster; and

FIG. 8 is a side perspective view of the caulking tube and nozzle retained in a caulking gun and the caulking gun retained in the caulking gun holster of the present invention.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

In the following discussion, numerous specific details are set forth to provide a thorough understanding of the present disclosure. However, those skilled in the art will appreciate that embodiments may be practiced without such specific details. Furthermore, lists and/or examples are often provided and should be interpreted as exemplary only and in no way limiting embodiments to only those examples.

Exemplary embodiments are described below in the accompanying Figures. The following detailed description provides a comprehensive review of the drawing Figures in order to provide a thorough understanding of, and an enabling description for, these embodiments. One having ordinary skill in the art will understand that in some cases well-known structures and functions have not been shown or described in detail to avoid unnecessarily obscuring the description of the embodiments.

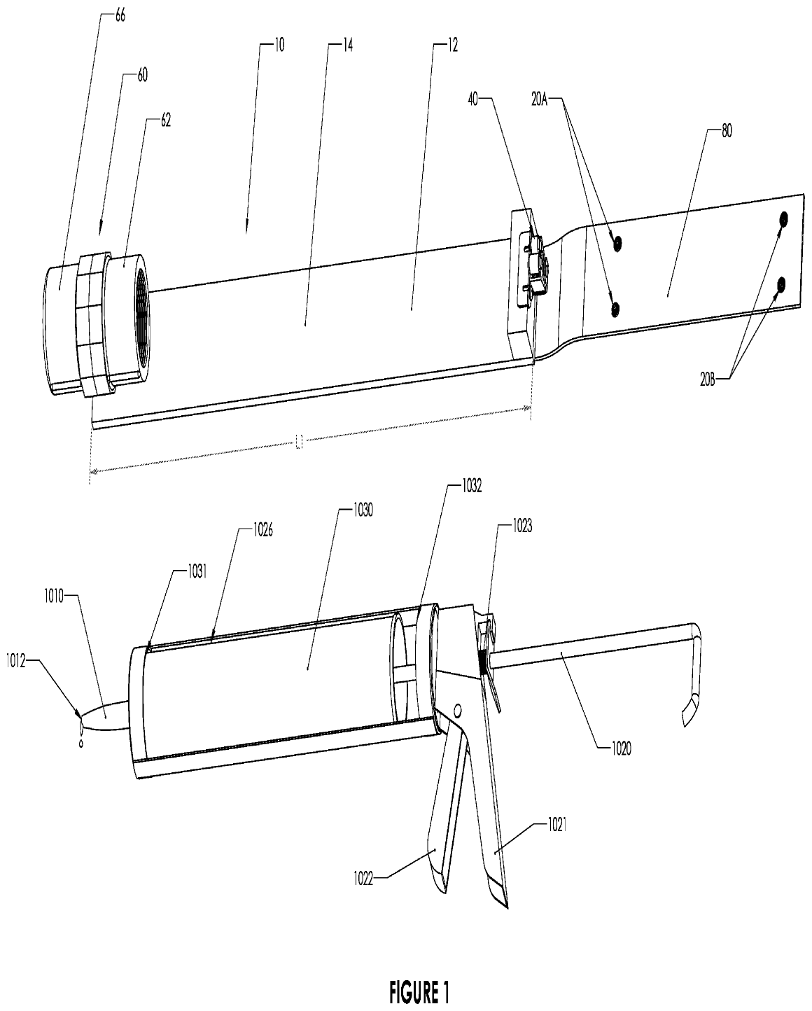

Referring to the figures, FIG. 1 illustrates the present invention caulking gun holster 10 having a rigid platform 12 with a length Li and a platform top surface 14. The lower part of the platform top surface 14 includes a two-part nozzle retention cap 60 comprising a retention ring 62, and a nozzle cup 66. The upper part of platform top surface 14 includes a ratchet retaining assembly 40 affixed to platform top surface 14, and a belt loop comprising a set of female snap fasteners 20A and corresponding male snap fastener 20B. The present invention caulking gun holster 10 is used by a construction worker or other person engaged in a construction activity where a sealant is required to seal a gap.

As depicted, a caulking tube 1030 includes a nozzle 1010 with a nozzle tip 1012. The caulking tube 1030 includes an exterior wall 1026 with a movable end wall 1032 and front wall 1031. A force from a caulking gun 1000 exerts a force on exterior end wall 1032 to push it into a chamber containing sealant. The chamber containing sealant is surrounded by the exterior wall 1026 and exits through nozzle exit 1012 as end wall 1032 induces an inner force to extrude sealant from the interior of caulking tube 1030.

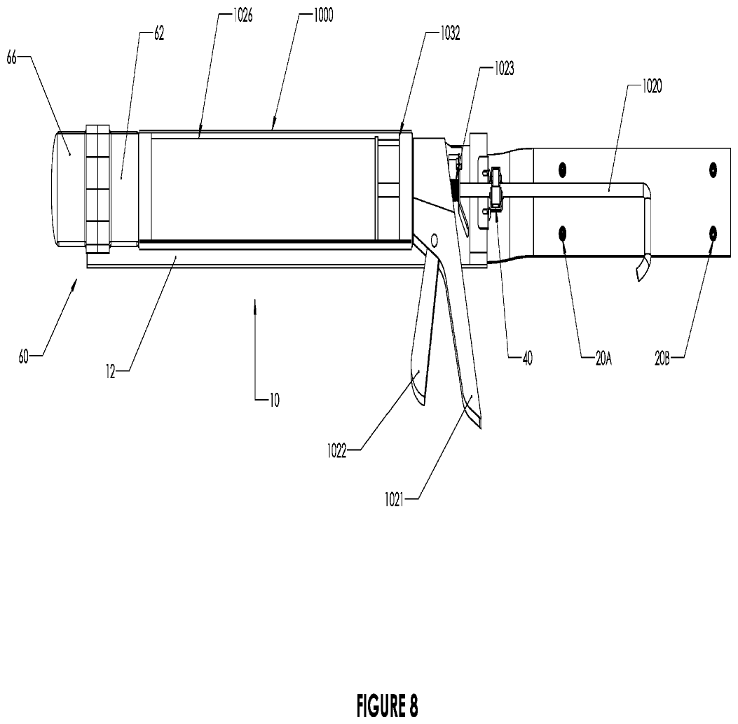

When engaged in a construction project, it is prudent to already have the caulking tube 1030 installed in the caulking gun 1000 as illustrated in FIG. 1. The caulking tube end wall 1032 rests against caulking gun ratchet 1020 which is moved by trigger 1022 to force sealant from the nozzle exit 1012. In use, a user holds grip 1021 and pulls trigger 1022 activating ratcheting mechanism 1023 to force sealant from nozzle exit 1012. The caulking tube 1030 is retained in the caulking gun 1000 as just described above and illustrated in FIG. 8.

The caulking gun 1000 is retained by the present invention caulking gun holster 10. For rapid use, the present invention caulking gun holster 10 is worn on a work belt and hangs against a worker's leg. In this way, the caulking gun 1000 with caulking tube 1030 retained in the caulking gun is ready for rapid use and rapid retention back in the caulking gun holster when the sealing operation is concluded.

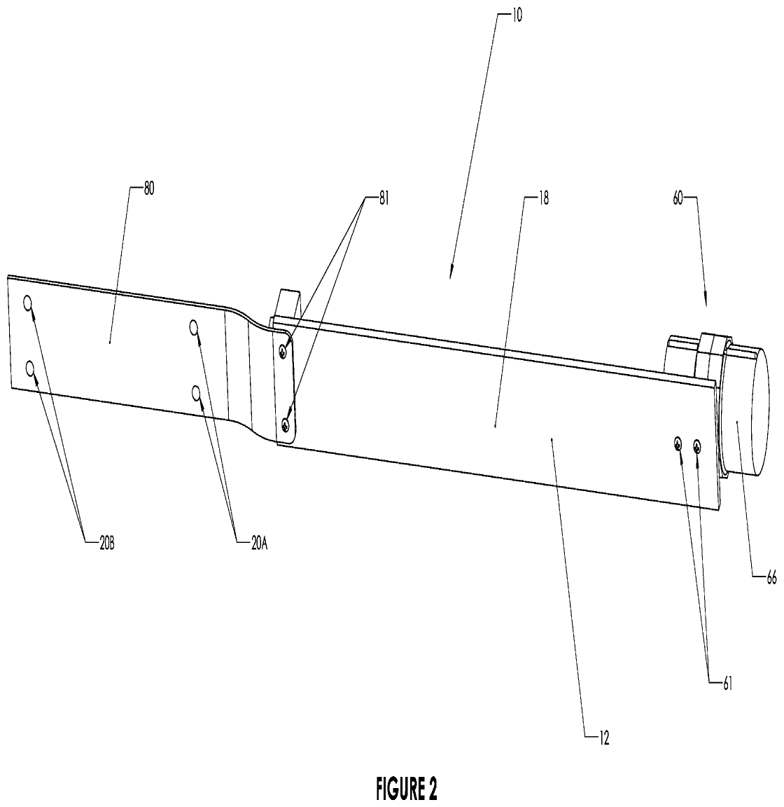

FIG. 2 illustrates the present invention caulking gun holster 10 as having a rigid platform 12 with a platform bottom surface 18. Referring to FIGS. 1 and 2, as depicted plastic retention cap 60 can be affixed by fasteners 61 (e.g., screw, rivet, bolt, etc.) to rigid platform 12. Alternatively, an adhesive, other commonly known affixing mechanisms and methods may be utilized. Collectively, these various affixing mechanisms can be referred to as affixing devices. The plastic retention cap 60 further comprises a removable nozzle cup 66 and retention ring 62, whereby the retention ring 62 and nozzle cup 66 can be joined together using a threaded screw coupling.

As depicted, the open belt loop 80 can be connected to rigid platform 12 by fasteners 82. The backside of snap fasteners 20A and 20B are further depicted. Fasteners 82 can comprise screws, rivets, or other convenient fastening devices.

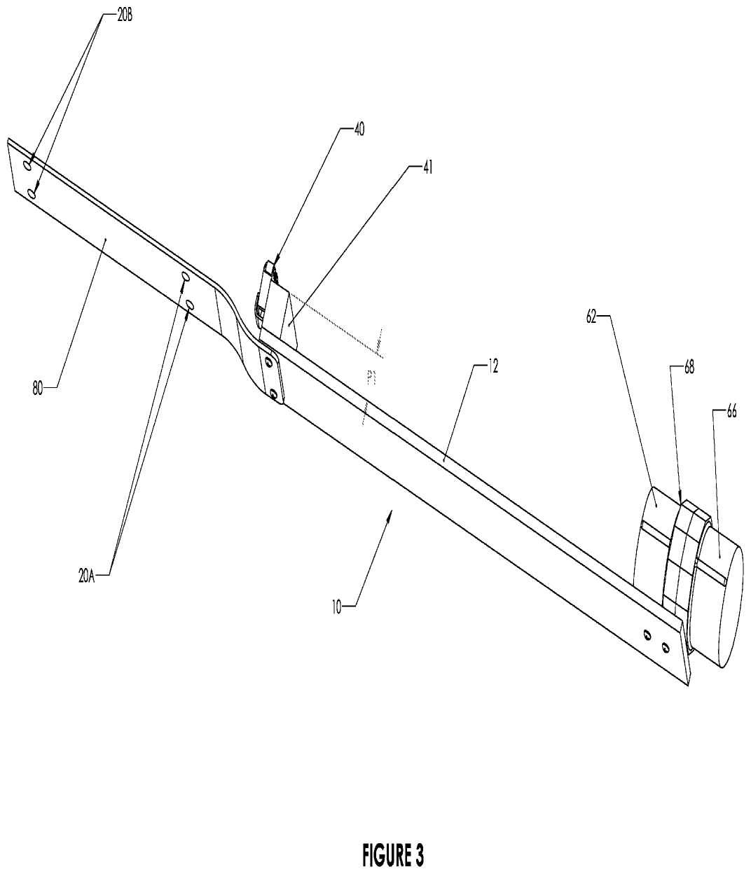

FIG. 3 depicts a side view of the caulking gun holster 10. Rigid platform 12 at the upper end includes a vertical spacer 41 to position ratchet retaining assembly 40 at the appropriate vertical height P₁ to retain ratchet 1020. Fasteners 20A and 20B can be connected together to loop belt loop over and attach the two ends together to over a belt.

As illustrated in FIG. 3, the vertical spacer 41 positions ratchet retaining assembly 40 at height P_{I} above top surface 14. Ratchet 1020 when placed within ratchet retaining assembly 40 can be tightly retained in place, also retaining the upper portion of caulking tube 1030 in place, to facilitate case of stowage and removal. Retention cap 60 receives nozzle 1010 with retention ring 62 sized to receive front wall 1031 to retain the lower portion of caulking tube 1030 in place.

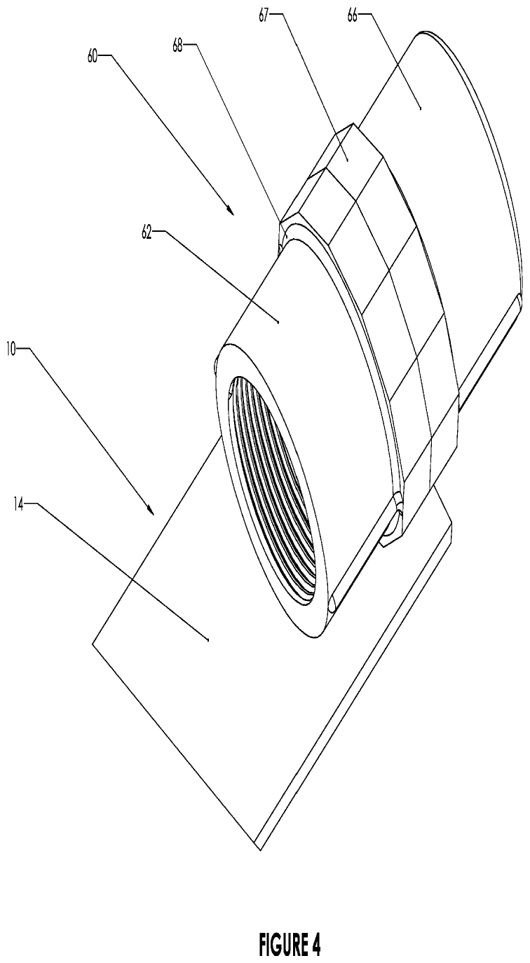

FIG. 4 depicts retention cap 60 in isolation. As depicted, rigid platform 10 includes retention cap 60 attached to top platform 14. Retention cap 60 can comprise retention ring 62, with a set of male screw threads 68 at its distal end. Nozzle cup 66 can comprise a matching set of female screw threads (not shown), and a faceted surface 67 around the upper rim of nozzle cup 66 to facilitate screwing and unscrewing to join and separate retention ring 62 with nozzle cup 66. The retention ring 62 can be affixed to platform 14 using an adhesive, an affixing device, or other commonly known affixing member, such as a rivet or a screw or adhesive.

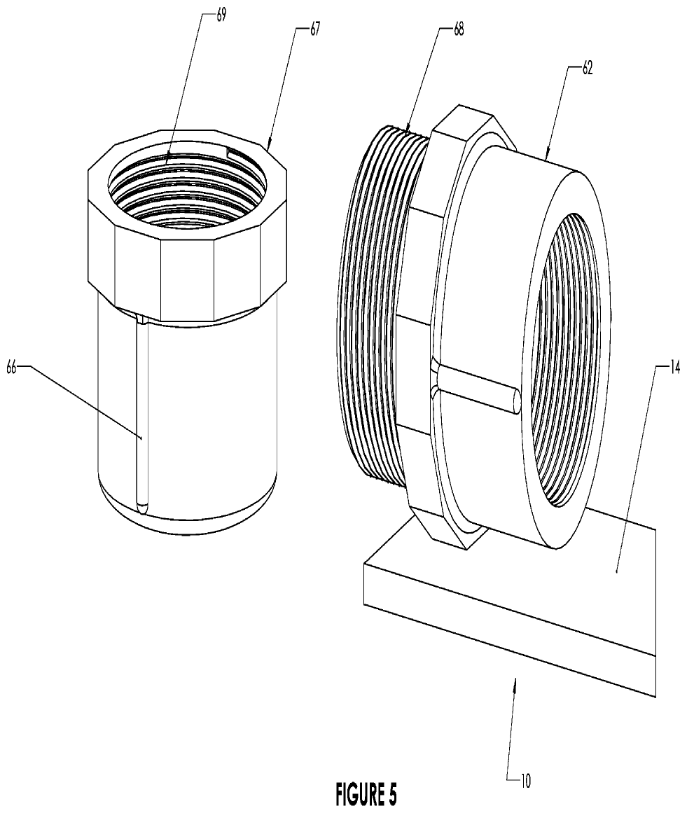

Referring to FIG. 5, the retention cap 60 is shown separated into its two component parts. The rigid platform 12 includes top platform surface 14, and retention ring 62 is attached to the top platform surface 14. As depicted, the lower end of retention ring 62 comprises male screw threads 68, while nozzle cup 66 includes matching female screw threads 69. Nozzle cup 66 further comprises faceted surface 67 around the circumference of nozzle cup 66 at the upper rim. The nozzle cup 66 screws and unscrews from retention ring 62.

In use, caulking material inside caulking tube 1000 will invariably leak from the interior of caulking tub 1000 when placed within the caulking gun holster 10 in a vertical orientation with nozzle 1010 pointing downward. Nozzle cup 66 catches any leaking caulking material when screwed in place on retention ring 62. Conversely, when unscrewed and removed, nozzle cup 66 can be cleaned of any leaked caulking material caught within the nozzle cup 66.

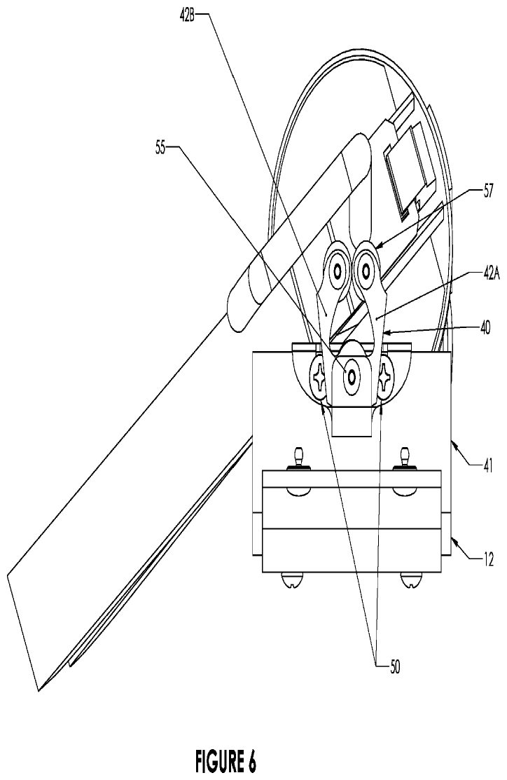

As depicted in FIG. 6, the ratchet retaining assembly 40 comprises a pair of opposed spring-loaded roller clamps 42A and 42B attached to vertical spacer 41 and configured to expand apart when a ratchet 1020 is inserted therein. As shown, the vertical spacer 41 affixed to rigid platform 12 positions the roller clamps 42A and 42B at an appropriate height to receive ratchet 1020. The opposed spring-loaded roller clamps 42A and 42B are biased toward a closed position, and each one of the spring-loaded roller clamps 42A and 42B are secured in place by fasteners 50, and the spring-loaded roller clamps 42A and 42B are installed so as rotate around pivot axle 55. Rollers 57 of the roller clamps 42A and 42B are made from plastic and easily rotate to facilitate easier insertion of ratchet 1020 between roller clamps 42A and 42B.

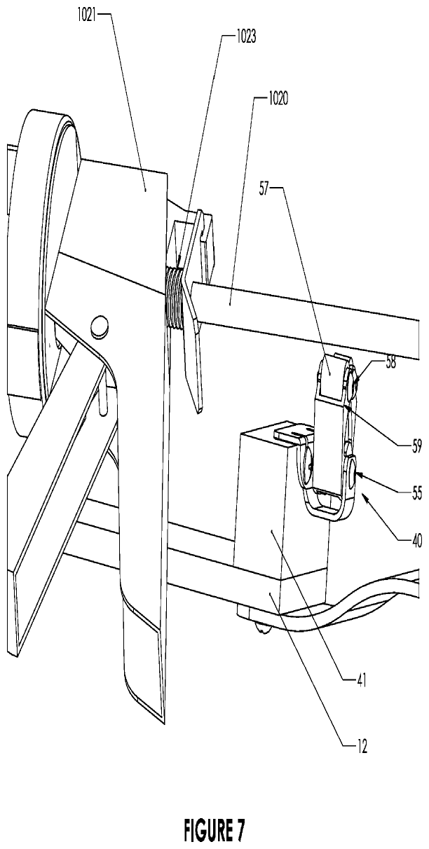

Referring to FIG. 7, as depicted, there is illustrated a side view of installed ratchet retaining assembly 40. As shown, the vertical spacer 41 affixed to rigid platform 12 positions the ratchet retaining assembly 40 at an appropriate height for rollers 57 to receive ratchet 1020. Support arm 59 supports plastic rollers 59 and these support arms 59 pivot around pivot axle 55. Rollers 57 of the roller clamps 42A and 42B are made from plastic and easily rotate to facilitate easier insertion of ratchet 1020. Ratchet 1020 moves forward by actuating ratcheting mechanism 1023, and ratchet 1020 is positioned above rollers 58 for inserting into the ratchet retaining assembly 40.

As depicted in FIG. 8, caulking gun holster 10 includes a caulking gun 1000 secured therein. Caulking gun holster 10 comprises a rigid platform 12 with a two-part nozzle retention cap 60 comprising retention ring 62 and nozzle cup 66. A ratchet retaining assembly 40 is affixed to rigid platform 12, and a belt loop comprising a set of female snap fasteners 20A and corresponding male snap fastener 20B is also attached.

A caulking tube 1030 fits into retention ring 62 and includes an exterior wall 1026 with a movable end wall 1032 and front wall 1031. A chamber containing sealant is surrounded by the exterior wall 1026 and end wall 1032 induces an inner force to extrude sealant from the interior of caulking tube 1030 when engaged by ratchet 1020. The trigger 1022 on handle 1021 causes ratchet 1020 to advance and force end wall 1032 into caulking tube 1030. Ratchet retention assembly 40 receives and closes around inserted ratchet 1020 to retain caulking gun 1030 in place in caulking gun holster 1030.

Insofar as the description above and the accompanying drawing disclose any additional subject matter that is not within the scope of the single claim below, the inventions are not dedicated to the public and the right to the one or more applications to claim such additional inventions is reserved.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

The foregoing has described methods and systems for a caulking gun holster that are given for illustration and not for limitation and uses. Thus the inventions are limited only by the appended claims. Although the inventions have been described in accordance with the embodiments shown, one of ordinary skill in the art will readily recognize that there could be variations to the embodiments and those variations would be within the spirit and scope of the present inventions. Accordingly, many modifications may be made by one of ordinary skill in the art without departing from the spirit and scope of the appended claims.

Particular terminology used when describing certain features or aspects of the embodiments should not be taken to imply that the terminology is being redefined herein to be restricted to any specific characteristics, features, or aspects with which that terminology is associated. In general, the terms used in the following claims should not be construed to be limited to the specific embodiments disclosed in the specification, unless the above Detailed Description section explicitly defines such terms. Accordingly, the actual scope of the claims encompasses not only the disclosed embodiments, but also all equivalent ways of practicing or implementing the claimed subject matter.

The above detailed description of the embodiments is not intended to be exhaustive or to limit the disclosure to the precise embodiment or form disclosed herein or to the particular fields of usage mentioned above. While specific embodiments and examples are described above for illustrative purposes, various equivalent modifications are possible within the scope of the disclosure, as those skilled in the relevant art will recognize. Also, the teachings of the embodiments provided herein can be applied to other systems, not necessarily the system described above. The elements and acts of the various embodiments described above can be combined to provide further embodiments.

Any patents, applications and other references that may be listed in accompanying or subsequent filing papers, are incorporated herein by reference. Aspects of embodiments can be modified, if necessary, to employ the systems, functions, and concepts of the various references to provide yet further embodiments.

In light of the above “Detailed Description,” the Inventor may make changes to the disclosure. While the detailed description outlines possible embodiments and discloses the best mode contemplated, no matter how detailed the above appears in text, embodiments may be practiced in a myriad of ways. Thus, implementation details may vary considerably while still being encompassed by the spirit of the embodiments as disclosed by the inventor. As discussed herein, specific terminology used when describing certain features or aspects should not be taken to imply that the terminology is being redefined herein to be restricted to any specific characteristics, features, or aspects of the embodiments with which that terminology is associated.

While certain aspects are presented below in certain claim forms, the inventor contemplates the various aspects in any number of claim forms, Accordingly, the inventor reserves the right to add additional claims after filing the application to pursue such additional claim forms for other aspects.

The above specification, examples and data provide a description of the structure and use of exemplary implementations of the described systems, articles of manufacture and methods. It is important to note that many implementations can be made without departing from the spirit and scope of the disclosure.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Various materials may be used to construct the disclosed caulking gun holster. For example, the holster may be constructed from polymer or acrylic, and can constructed as a single piece taken from mold. Or, the holster can be made from multiple components, such as polymer or acrylic (or other similar materials) with metal components attached to or molded therein. A stiff leather or plastic may also be used or wood.

Other embodiments of a rotatable nozzle cup and retention cap may be used to facilitate rotating removal and replacement of the nozzle cap.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. An apparatus for retaining a caulking gun with a caulking tube, the apparatus comprising:
a. a rigid platform having a length and a platform top surface having a retention cap and a ratchet retaining assembly affixed to said platform top surface;
b. at least one loop member adjacent to a top of said rigid platform of a caulking gun holster body, with said at least one loop member affixed to said platform;
c. the ratchet retaining assembly comprising two oppositely oriented spring-loaded roller clamps and configured so as to expand apart when a caulking gun ratchet of a caulking gun is inserted therein;
d. a nozzle of a caulking tube in the caulking gun inserted into the retention cap to retain the nozzle therein, with said nozzle at a front end of the caulking gun and having a rear end of the caulking gun comprising a caulking gun ratchet, the caulking gun ratchet placed into the spring-loaded roller clamps, and the caulking gun ratchet pressed downwards into the spring-loaded roller clamps, so the spring-loaded roller clamps close on the caulking gun ratchet to retain the caulking gun ratchet.

2. The apparatus for retaining a caulking gun with a caulking tube of claim 1, further comprising:
e. the caulking gun holster retained by the at least one loop member around a worker's belt and configured for wearing on a user's waist, the caulking gun holster positioned adjacent to a user's leg facilitating rapid grasping of the caulking gun, with the caulking tube and nozzle configured to dispense caulking compound retained in the caulking tube, and when caulking is completed, the caulking gun replaced and retained in the caulking gun holster.

3. The apparatus for retaining a caulking gun with a caulking tube of claim 1, further comprising:
e. the nozzle retention cap comprised of a retention ring for receiving the caulking gun nozzle and a removable nozzle cup; and
f. the removable nozzle cap and retention ring further comprising corresponding male and female screw threads, wherein the removable nozzle cup can be unscrewed and removed to facilitate cleaning of leaked caulking material.

4. A caulking gun holster retaining a caulking gun, the holster comprising:
a rigid platform having a length and a platform top surface having a retaining ring with removable nozzle cup and a ratchet retaining assembly affixed to the platform top surface;
a loop member at a top of the rigid platform and affixed to the rigid platform to receive a belt;
wherein the caulking gun holster can receive a caulking gun place thereon with a ratchet of the caulking gun retained by the ratchet retaining assembly and the retaining ring retaining a nozzle end of the caulking gun, a nozzle of the caulking gun fitting into the nozzle cup.

5. The caulking gun of claim 4, further comprising:
the ratchet retaining assembly comprising two oppositely positioned roller clamps with said ratchet retaining assembly attached to a vertical spacer affixed to the platform top surface.

6. The caulking gun of claim 5, further comprising:
the two oppositely positioned roller clamps further comprise two plastic rollers.

7. The caulking gun of claim 4, further comprising:
the nozzle of the caulking gun positioned through the retention ring with the retention ring sized to receive the nozzle end, and the nozzle cup positioned over the nozzle, wherein the retention ring and nozzle cup further comprise corresponding screw threads for screwing and unscrewing the retention ring and nozzle cup together and apart.

8. The caulking gun of claim 7, further comprising:
the loop member comprising two ends, with male and corresponding female fasteners positioned at either end and configured so as to loop together and fasten.

9. The caulking gun of claim 8, further comprising:
the caulking gun holster retained by the loop member passed around a belt and snapped together using male and female snaps.

10. The caulking gun of claim 4, further comprising:
the nozzle cup rotatably affixed and retained to the retaining ring so as to rotate to facilitate removal of any accumulated caulking material;
wherein the nozzle cup after emptying rotates to an original position for the nozzle cup to fit over the nozzle.

11. A device retaining a caulking gun for use, the device comprising:
a rigid platform having a top surface, with a caulking gun retaining ring and a ratchet retaining assembly affixed to the top surface;
a loop member at a top of the rigid platform and affixed to the rigid platform to receive a belt;
wherein the caulking gun holster can receive a caulking gun placed thereon with a ratchet of the caulking gun retained by the ratchet retaining assembly and the caulking gun retaining ring retaining a nozzle end of a caulking tube of the caulking gun.

12. The device retaining a caulking gun for use of claim 11, further comprising:
the caulking gun retaining ring further comprising a nozzle cup removably positioned below the caulking gun retaining ring for covering a nozzle of the caulking gun.

13. The device retaining a caulking gun for use of claim 11, further comprising:
the nozzle cup rotatably affixed to the retaining ring to rotate and remove for cleaning of any caulking material leaked from the caulking tube.

14. The device retaining a caulking gun for use of claim 11, further comprising:
the ratchet retaining assembly comprising two oppositely positioned clamps configured to receive and retain the ratchet of the caulking gun when placed in the device.

15. The device retaining a caulking gun for use of claim 11, further comprising:
two oppositely positioned spring-loaded roller clamps extending upward from the platform using a vertical spacer and configured to expand, receive, and retain the ratchet of the caulking gun when pressed into the roller clamps.

16. The device retaining a caulking gun for use of claim 11, further comprising:
the nozzle of the caulking tube of the caulking gun positioned through the retaining ring, with said retaining ring sized to accommodate and receive the nozzle end of the caulking gun and retain the nozzle end therein; and
the caulking gun ratchet placed into the ratchet retaining assembly so as to force two spring-loaded retaining clamps open to receive said ratchet, with the retaining clamps then closing to retain the ratchet therein.

17. The device retaining a caulking gun for use of claim 16, further comprising:
the retaining ring comprised of a set of screw threads on an end opposite the nozzle; and
a nozzle cup comprised of a set of screw threads configured to screw onto the retaining ring.

18. The device retaining a caulking gun for use of claim 16, further comprising:
each of the two spring-loaded retaining clamps comprising plastic rollers.

19. The device retaining a caulking gun for use of claim 11, further comprising:
a nozzle cup rotatably affixed to the retaining ring so as to rotate and facilitate removal to clean of any caulking material accumulated from the caulking tube;
wherein the nozzle cup after emptying rotates to an original position for the nozzle cup to fit onto the retaining ring.

20. The device retaining a caulking gun for use of claim 11, further comprising:
the loop member comprising fasteners to fasten the loop member onto a belt and thereby attach to the waist of a user.
